(19) United States
(12) Patent Application Publication
(10) Pub. No.: US 2022/0272938 A1
(43) Pub. Date: Sep. 1, 2022

(54) SPLITABLE MODULAR DOGHOUSE

(71) Applicants: Yong Li, Shanghai (CN); Xiaoming Li, Shanghai (CN); shanghai logos innovations intelligent technology company limited, Shanghai (CN)

(72) Inventors: Xiaoming Li, Shanghai (CN); Yong Li, Shanghai (CN)

(21) Appl. No.: 17/245,251

(22) Filed: Apr. 30, 2021

(30) Foreign Application Priority Data
Feb. 26, 2021 (CN) 2021102176573

(51) Int. Cl. A01K 1/03; F16B 5/00

(52) U.S. Cl. CPC A01K 1/033; F16B 5/006

(57) ABSTRACT

A splitable modular doghouse includes: a first doghouse body, a second doghouse body, and locking assemblies. A side of the first doghouse body and a side of the second doghouse body can be operatively and detachably connected through the locking assemblies. The doghouse bodies of the splitable modular doghouse are detachably connected through the locking assemblies, so as to adapt to a body size of a dog. Therefore, it is convenient to replace a damaged doghouse body and thus the cost can be reduced consequently.

### TECHNICAL FIELD

The invention relates to the field of doghouse technology, and more particularly to a splitable modular doghouse.

### DESCRIPTION OF RELATED ART

For doghouse products currently available on the market, they usually have been designed in fixed-sizes. However, during the lifetime of a dog, a body size of the dog keeps growing and changing after birth. Growth cycles of small dogs, medium dogs, and large dogs usually are ranged from 6 months to 16 months. The body size of the dog keeps getting bigger throughout the growth cycle. Therefore, the one-piece structured doghouses with fixed sizes on the current market are in contradiction with changes of body size of a dog during its growth cycle, and cannot effectively meet the requirements of size changes of a doghouse for a dog due to the change of body size of the dog.

In order to facilitate the dog to sleep and rest comfortably during its growth cycle, the doghouse can only be replaced with a larger doghouse as the change of body size of the dog. Many families need to replace the doghouse more than once during the growth cycle of the dog to meet the requirements of larger sized doghouses resulting from the change of body size of the dog.

Beside the aforementioned requirements of changing the size of the doghouse resulting from the change of body size of the dog, the dog itself may also damage the doghouse due to playing and biting the doghouse. For a one-piece structured doghouse in a fixed size, once the doghouse is torn and damaged and cannot be repaired, the entire doghouse needs to be discarded and thus the cost is high.

### SUMMARY

In view of the above-mentioned problems of the existing doghouses, an objective of the invention is to provide a splitable modular doghouse. The doghouse can be separated/disassembled into several doghouse bodies. The several doghouse bodies are detachably connected through locking assemblies, so as to adapt to a body size of a dog. It is convenient to replace a damaged doghouse body and thus the cost can be reduced consequently.

The specific technical solutions may be as follows.

In an embodiment a splitable modular doghouse may include: a first doghouse body, a second doghouse body, and locking assemblies. A side of the first doghouse body is operatively and detachably connected to a side of the second doghouse body through the locking assemblies.

In the above-mentioned splitable modular doghouse, a top part of a sidewall of the first doghouse body is provided with a first boss, a bottom part of a sidewall of the second doghouse body is provided with a second boss, and the first boss is located just above the second boss.

In another embodiment, a splitable modular doghouse may include: a first doghouse body, a second doghouse body, and at least one third doghouse body. A side of the first doghouse body and a first side of the at least one third doghouse body, as well as a side of the second doghouse body and a second side of the as least one third doghouse body, are operatively and detachably connected through locking assemblies.

In the above-mentioned splitable modular doghouse, the at least one third doghouse body may include several (i.e., more than one) third doghouse bodies, and a side of each of the several third doghouse bodies is operatively and detachably connected to another side of another of the several third doghouse bodies through the locking assemblies.

In the above-mentioned splitable modular doghouse, a top part of a sidewall of the first doghouse body may be provided with a first boss, a bottom part of a sidewall of the second doghouse body may be provided with a second boss, a bottom part of a first sidewall of the at least one third doghouse body may be provided with a second boss, and a top part of a second sidewall of the at least one third doghouse body may be provided with a first boss. The first boss of the first doghouse body is located just above the second boss of the at least one third doghouse body, and the first boss of the at least one third doghouse body is located just above the second boss of the second doghouse body.

In the above-mentioned splitable modular doghouse, each of the locking assemblies may include: a snap member, a lock member, and two snap rings. The snap member and a first snap ring of the two snap rings are both disposed on the first boss, and the snap member is engaged with the first snap ring. The lock member and a second snap ring of the two snap rings are both disposed on the second boss, and the lock member is engaged with the second snap ring. The snap member is engaged with the lock member.

In the above-mentioned splitable modular doghouse, the first boss may be provided with a first through-groove, the second boss may be provided with a second through-groove, and the first through-groove is aligned with the second through-groove.

In an embodiment, an upper end of the snap member is engaged with and positionally limited by an upper surface of the first boss, and a lower end of the snap member extends into the first through-groove. A lower end of the first snap ring is engaged with and positionally limited by a lower surface of the first boss, and an upper end of the first snap ring extends into the first through-groove and is snapped with the lower end of the snap member.

In an embodiment, an upper end of the lock member is engaged with the snap member, a middle part of the lock member is engaged with and positionally limited by an upper surface of the second boss, and a lower end of the lock member extends into the second through-groove. A lower end of the second snap ring is engaged with and positionally limited by a lower surface of the second boss, and an upper end of the second snap ring extends into the second through-groove and is snapped with the lower end of the lock member.

In the above-mentioned splitable modular doghouse, the lock member may include a first lock portion and a second lock portion sequentially connected along a direction from top to bottom. An upper end of the second lock portion is engaged with and positionally limited by the upper surface of the second boss, and a lower end of the second lock portion extends into the second through-groove. The upper end of the second snap ring is snapped with the lower end of the second lock portion, and the first lock portion extends into the snap member and is engaged with the snap member.

In the above-mentioned splitable modular doghouse, the lower surface of the first boss at a periphery of the first through-groove may be formed with a first groove, the upper surface of the second boss at a periphery of the second through-groove may be formed with a second groove, and the first groove is opposite to the second groove. The lower end of the first snap ring is disposed in the first groove, and the upper end of the second lock portion is disposed in the second groove.

In the above-mentioned splitable modular doghouse, two sides of an inner circumferential wall of the snap member may be provided with two stopping plates. A through cavity may be formed between the two stopping plates. A middle part of the upper end of the second lock portion may be provided with a protruding neck, the protruding neck passes through the through cavity, and the first lock portion is positionally limited by the stopping plates.

Compared with the prior art, the above-mentioned technical solutions may have the following beneficial effects:

(1) In some embodiment of the invention, the first doghouse body and the second doghouse body are detachably connected through locking assemblies, and thus a minimum sized assembly of the doghouse can be realized.

(2) In some embodiment of the invention, at least one third doghouse body is arranged between the first doghouse body and the second doghouse body. Moreover, the first doghouse body, the second doghouse body and the at least one third doghouse body are detachably connected to one another by locking assemblies, and the number of the at least one third doghouse body can be determined by a size of the dog.

(3) In the embodiments of the invention, the locking assembly may be a double-layer snap-fit/buckle structure, and a mutual connection between every two adjacent doghouse bodies can be realized through the double-layer buckle structure, so that different combinations of doghouse bodies can be realized, the structure is relatively simple, and the cost is relatively low.

(4) In the embodiments of the invention, for the splitable modular doghouse, it can maintain its integrity by replacing a corresponding damaged doghouse body of the splitable modular doghouse, the waste can be reduced, and it is more environmentally friendly consequently.

### BRIEF DESCRIPTION OF THE DRAWINGS

FIG. 1 is a schematic view of an overall structure of a splitable modular doghouse without a third doghouse body according to an embodiment of the invention.

FIG. 2 is a schematic exploded structural view of the splitable modular doghouse without a third doghouse body according to an embodiment of the invention.

FIG. 3 is a schematic view of an overall structure of a splitable modular doghouse provided with a third doghouse body according to another embodiment of the invention.

FIG. 4 is a schematic exploded structural view of the splitable modular doghouse provided with the third doghouse body according to the another embodiment of the invention.

FIG. 5 is a schematic longitudinal cross-sectional view of a splitable modular doghouse according to an embodiment of the invention.

FIG. 6 is a schematic enlarged cross-sectional view of showing a locking assembly of a splitable modular doghouse according to an embodiment of the invention.

FIG. 7 is a schematic top view of a locking assembly of a splitable modular doghouse according to an embodiment of the invention.

FIG. 8 is a schematic exploded structural view of a locking assembly of a splitable modular doghouse according to an embodiment of the invention.

FIG. 9 is a schematic structural view of a snap member of a splitable modular doghouse according to an embodiment of the invention.

FIG. 10 is a schematic structural view of a snap ring of a splitable modular doghouse according to an embodiment of the invention.

FIG. 11 is a schematic structural view of a third doghouse body of a splitable modular doghouse according to an embodiment of the invention.

FIG. 12 is another schematic structural view of the third doghouse body of a splitable modular doghouse according to an embodiment of the invention.

In the drawings: 1, first doghouse body; 2, second doghouse body; 3, third doghouse body; 4, locking assembly; 5, first boss; 6, second boss; 7, annular retaining wall; 8, notch; 11, snap member; 12, lock member; 13, snap ring; 14, first through-groove; 15, second through-groove; 16, first lock portion; 17, second lock portion; 18, first groove; 19, second groove; 20, third groove; 21, stopping plate; 22, through cavity; 23, protruding neck; 24, flange; 25, gap.

### DETAILED DESCRIPTION OF EMBODIMENTS

The invention is further described below in detail in combination with the drawings and specific embodiments, but it is not a limitation of the invention.

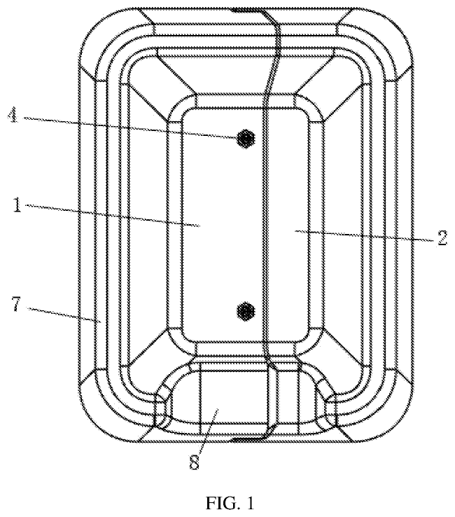

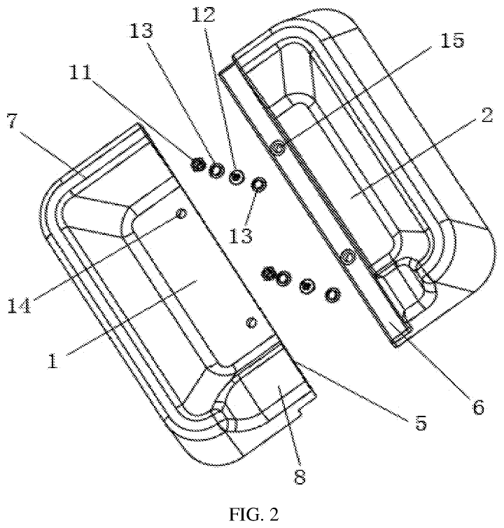

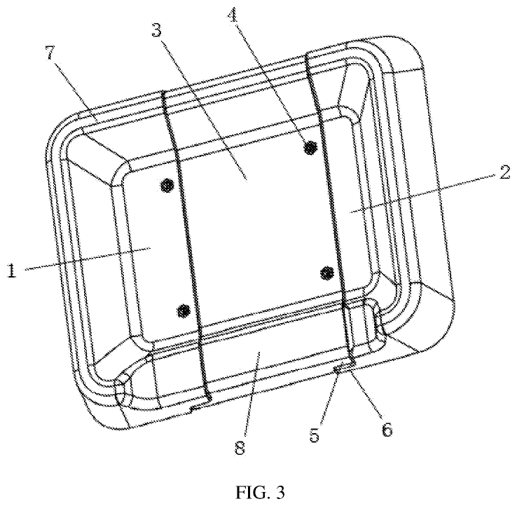

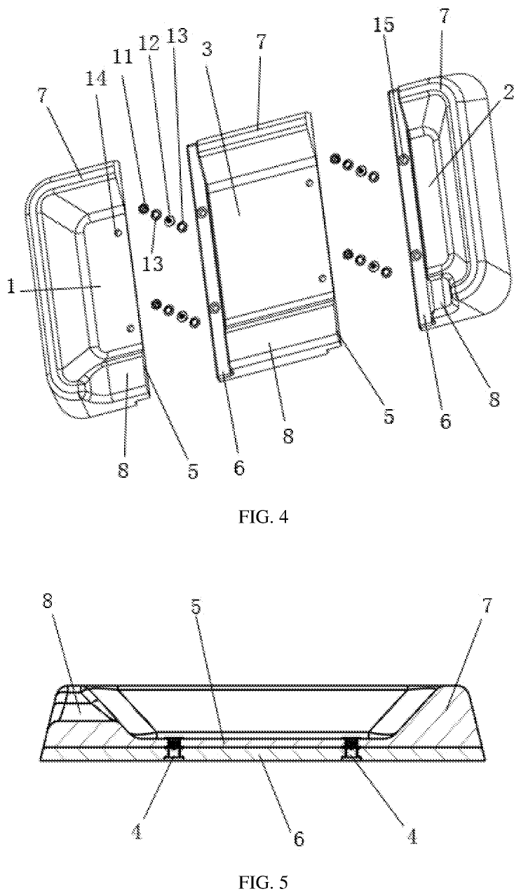

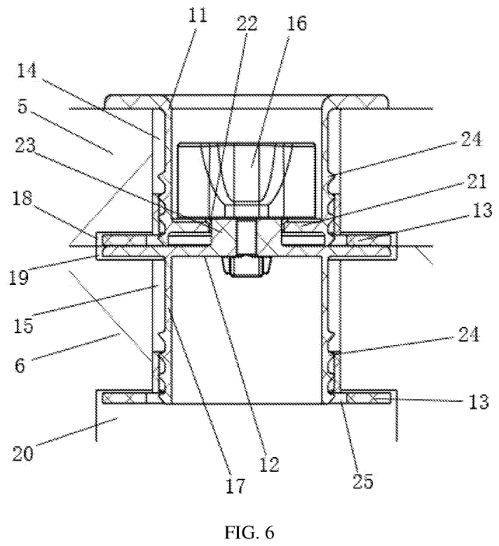

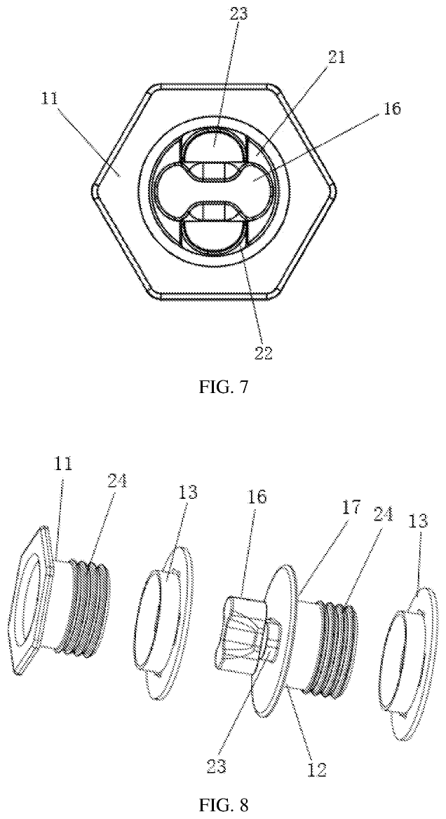

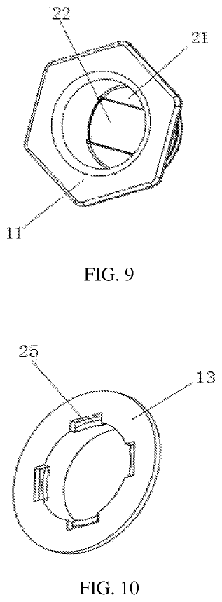

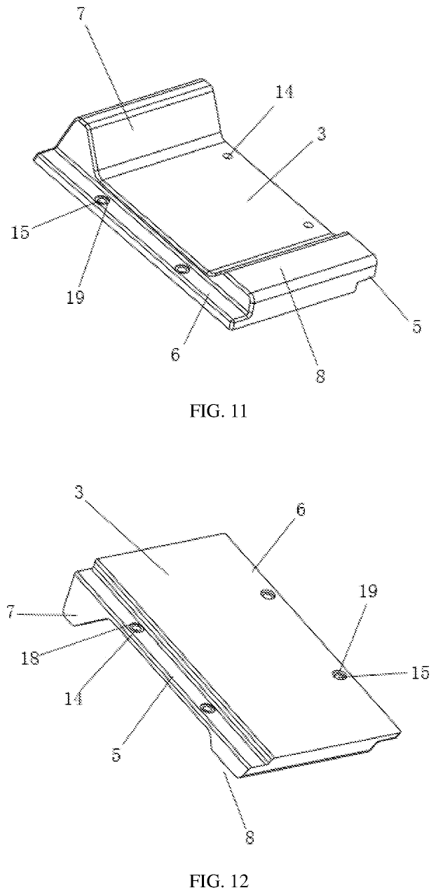

FIG. 1 is a schematic view of an overall structure of a splitable modular doghouse without a third doghouse body according to an embodiment of the invention, FIG. 2 is a schematic exploded structural view of the splitable modular doghouse without a third doghouse body according to the embodiment of the invention, FIG. 3 is a schematic view of an overall structure of a splitable modular doghouse provided with a third doghouse body according to another embodiment of the invention, FIG. 4 is a schematic exploded structural view of a splitable modular doghouse provided with the third doghouse body according to the another embodiment of the invention, FIG. 5 is a schematic longitudinal cross-sectional view of a splitable modular doghouse according to an embodiment of the invention, FIG. 6 is a schematic enlarged cross-sectional view of showing a locking assembly of a splitable modular doghouse according to an embodiment of the invention, FIG. 7 is a schematic top view of a locking assembly of a splitable modular doghouse according to an embodiment of the invention, FIG. 8 is a schematic exploded structural view of a locking assembly of a splitable modular doghouse according to an embodiment of the invention, FIG. 9 is a schematic structural view of a snap member of a splitable modular doghouse according to an embodiment of the invention, FIG. 10 is a schematic structural view of a snap ring of a splitable modular doghouse according to an embodiment of the invention, FIG. 11 is a schematic structural view of a third doghouse body of a splitable modular doghouse according to an embodiment of the invention, and FIG. 12 is another schematic structural view of the third doghouse body of a splitable modular doghouse according to an embodiment of the invention. As shown in FIG. 1 through FIG. 12, a splitable modular doghouse shown in a preferred embodiment may include: a first doghouse body 1, a second doghouse body 2, and locking assemblies 4. A side of the first doghouse body 1 is operatively and detachably connected to a side of the second doghouse body 2 through the locking assemblies 4.

Further, as a preferred embodiment, a top part/portion of a sidewall of the first doghouse body 1 is provided with a first boss 5, and a bottom part/portion of a sidewall of the second doghouse body 2 is provided with a second boss 6. The first boss 5 is located just above the second boss 6.

Preferably, the first boss 5 is matched with the second boss 6.

Preferably, the first doghouse body 1 and the second doghouse body 2 after being connected as a whole define/form an annular retaining wall 7. A side of the annular retaining wall 7 is provided a notch 8.

As shown in FIGS. 3 and 4, a splitable modular doghouse as a preferred embodiment may include: a first doghouse body 1, a second doghouse body 2, and at least one third doghouse body 3 (only one third doghouse body 3 is shown for the purpose of illustration). A side of the first doghouse body 1 and a first side of the at least one third doghouse body 3, as well as a side of the second doghouse body 2 and a second side of the at least one third doghouse body 3, are operatively and detachably connected by locking assemblies 4. More specifically, as exemplarily shown in FIG. 3 and FIG. 4, the right side of the first doghouse body 1 and the left side of the third doghouse body 3 is operatively and detachably connected by two locking assemblies 4, and the left side of the second doghouse body 2 and the right side of the third doghouse body 3 is operatively and detachably connected by two locking assemblies 4.

For a splitable modular doghouse of a preferred embodiment, the at least one third doghouse body 3 may include multiple/several third doghouse bodies 3. A side of each of the several third doghouse bodies 3 is operatively and detachably connected to another side of another of the several third doghouse bodies 3 through the locking assemblies 4. For example, a right side of one third doghouse body 3 is operatively and detachably connected to a left side of another third doghouse body 3, or a left side of one third doghouse body 3 is operatively and detachably connected to a right side of another third doghouse body 3.

Preferably, the several third doghouse bodies 3 are connected in sequence.

Preferably, another splitable modular doghouse may include: a first doghouse body 1, a second doghouse body 2, and several third doghouse bodies 3. The several third doghouse bodies 3 are connected in sequence through locking assemblies 4.

Further, as a preferred embodiment, a top part/portion of a sidewall of the first doghouse body 1 is provided with a first boss 5, and a bottom part/portion of a sidewall of the second doghouse body 2 is provided with a second boss 6. A bottom part of a first sidewall of each third doghouse body 3 is provided with a second boss 6, and a top part of a second sidewall of each third doghouse body 3 is provided with a first boss 5. The first boss 5 of the first doghouse body 1 is located just above the second boss 6 of a corresponding third doghouse body 3, and the first boss 5 of the a corresponding third doghouse body 3 is located just above the second boss 6 of the second doghouse body 2.

Preferably, the first boss 5 is matched with the second boss 6 adjacent thereto.

Preferably, the first boss 5 and the adjacent second boss 6 are mutually positionally limited, so that a lower surface of the doghouse as assembled is located in a first plane, and an upper surface inside the doghouse as assembled is located in a second plane.

Preferably, the first doghouse body 1, the several third socket bodies 3 and the second doghouse body 2 after being connected as a whole define/form an annular retaining wall 7, and a side of the annular retaining wall 7 is provided with a notch 8.

Preferably, the first boss 5 is connected to the second boss 6 through at least two locking assemblies 4.

Furthermore, as a preferred embodiment, each of the locking assemblies 4 may include: a snap member 11, a lock member 12, and two snap rings 13. The snap member 11 and a first snap ring of the two snap rings 13 (i.e., one of the two snap rings 13) are both disposed on the first boss 5, and the snap member 11 is engaged with the first snap ring 13. The lock member 12 and a second snap ring of the two snap rings 13 (i.e., the other one of the two snap rings 13) are both disposed on the second boss 6, and the lock member 12 is engaged with the second snap ring 13. The snap member 11 is engaged with the lock member 12.

The above embodiments are only preferred embodiments of the invention, rather than limit implementations and a protection scope of the invention.

On the basis of the above description, the invention may further have the following implementations.

In a further embodiment of the invention, referring to FIG. 1 through FIG. 12, the first boss 5 is provided with a first through-groove(s) 14, the second boss 6 is provided with a second through-groove(s) 15, and the first through-groove(s) 14 is/are aligned with the second through-groove(s) 15.

Preferably, at least two first through-grooves 14 are disposed on the first boss 5, and at least two second through-grooves 15 are disposed on the second boss 6.

In a further embodiment of the invention, as exemplarily shown in FIG. 6 and FIG. 7, an upper end of the snap member 11 is engaged with and positionally limited by an upper surface of the first boss 5, a lower end of the snap member 11 extends into the first through-groove 14, a lower end of the first snap ring 13 is engaged with and positionally limited by a lower surface of the first boss 5, and an upper end of the first snap ring 13 extends into the first through-groove 14 and is snapped with the lower end of the snap member 11.

In a further embodiment of the invention, as exemplarily shown in FIG. 6 and FIG. 7, an upper end of the lock member 12 is engaged with the snap member 11, a middle part/portion of the lock member 12 is engaged with and positionally limited by an upper surface of the second boss 6, a lower end of the lock member 12 extends into the second through-groove 15, a lower end of the second snap ring 13 is engaged with and positionally limited by a lower surface of the second boss 6, and an upper end of the second snap ring 13 extends into the second through-groove 15 and is snapped with the lower end of the lock member 12.

In a further embodiment of the invention, the lock member 12 may include a first lock portion 16 and a second lock portion 17 sequentially/successively connected along a direction from top to bottom (as exemplarily shown in FIG. 8). As exemplarily shown in FIG. 6, an upper end of the second lock portion 17 is engaged with and positionally limited by the upper end of the second boss 6, a lower end of the second lock portion 17 extends into the second through-groove 15, the upper end of the second snap ring 13 is snapped with the lower end of the second lock portion 17, and the first lock portion 16 extends into the snap member 11 and is engaged with the snap member 11.

In a further embodiment of the invention, as exemplarily illustrated in FIG. 6, the lower surface of the first boss 5 at a periphery of the first through-groove 14 is provided/formed with a first groove 18, the upper surface of the second boss 6 at a periphery of the second through-groove 15 is provided/formed with a second groove 19, and the first groove 18 is opposite to the second groove 19.

In a further embodiment of the invention, as exemplarily illustrated in FIG. 6, the lower end of the first snap ring 13 is disposed in the first groove 18, and the upper end of the second lock portion 17 is disposed in the second groove 19.

Preferably, as exemplarily illustrated in FIG. 6, the lower surface of the second boss 6 at a periphery of the second through-groove 15 is provided/formed with a third groove 20. The third groove 20 is rightly opposite to the second groove 19, and the lower end of the second snap ring 13 is disposed in the third groove 20.

In a further embodiment of the invention, as exemplarily shown in FIG. 6 through FIG. 8, the snap member 11 may be a hollow barrel-shaped structure, two sides of an inner circumferential wall of the snap member 11 are provided with two stopping plates 21. A through cavity 22 is defined/formed between the two stopping plates 21. A middle part/portion of the upper end of the second lock portion 17 is provided with a protruding neck 23. The protruding neck 23 passes through the through cavity 22, and the first lock portion 16 is positionally limited by the stopping plates 21.

Preferably, the first lock portion 16 is located just above the protruding neck 23.

Preferably, the first lock portion 16 is rotatably connected to the second lock portion 17.

Preferably, a periphery of the lower end of the snap member 11, as well as a periphery of the lower end of the lock member 12 are provided/formed with several flanges 24. The several flanges 24 on the snap member 11 are snapped with an inner circumferential wall of the upper end of the second snap ring 13, and the several flanges 24 on the lock member 12 are snapped with the inner circumferential wall of the upper end of second snap ring 13.

Preferably, a middle of each snap ring 13 is provided/formed with several notches 25 along a circumferential direction of the snap ring 13. The several notches 25 are snapped with corresponding flanges 24, and thus snapping and fastening abilities of the bottom-most flanges 24 can be improved.

Preferably, the several notches 25 are arranged at equal intervals along the circumferential direction of the snap ring 13, in other words, the several notches 25 are equidistantly arranged along the circumferential direction of the snap ring 13.

Preferably, a cross-section of each the snap ring 13 is L-shaped, a cross-section of the snap member 11 is L-shaped, a cross-section of the second lock portion 17 is L-shaped, and the upper end of the snap member 11 is a regular hexagon in shape.

In some embodiment of the invention, the first doghouse body 1 is connected to the second doghouse body 2 through the locking assemblies 4, so that a minimum sized assembly of the doghouse can be realized.

In some embodiment of the invention, at least one third doghouse body 3 is arranged between the first doghouse body 1 and the second doghouse body 2, and the first doghouse body 1, the second doghouse body 2 and the at least one third doghouse body 3 are connected one after another by the locking assemblies 4, and the number of the third doghouse bodies 3 can be determined by a size of the dog.

In some embodiment of the invention, the locking assembly 4 may be a double-layer snap-fit/buckle structure. A mutual connection between every two adjacent doghouse bodies can be realized through the double-layer buckle structure, so that different combinations of doghouse bodies can be realized, the structure is relatively simple, and the cost is relatively low.

For the splitable modular doghouse associated with any one of the embodiments of the invention, it can maintain its integrity by replacing a corresponding damaged doghouse body of the splitable modular doghouse, the waste can be reduced, and it is more environmentally friendly consequently.

The foregoing descriptions are only preferred embodiments of the invention, rather than limit the implementation and protection scope of the invention. For those skilled in the art, it should be understood that the solutions obtained by any equivalent substitutions and obvious changes made using the above description and drawings of the invention should all be included in the protection scope of the invention.

What is claimed is:

1. A splitable modular doghouse, comprising: a first doghouse body, a second doghouse body, and locking assemblies;
wherein a side of the first doghouse body is operatively and detachably connected to a side of the second doghouse body through the locking assemblies.

2. The splitable modular doghouse as claimed in claim 1, wherein a top part of a sidewall of the first doghouse body is provided with a first boss, and a bottom part of a sidewall of the second doghouse body is provided with a second boss, and the first boss is located just above the second boss.

3. A splitable modular doghouse, comprising: a first doghouse body, a second doghouse body, and at least one third doghouse body;
wherein a side of the first doghouse body and a first side of the at least one third doghouse body, as well as a side of the second doghouse body and a second side of the at least one third doghouse body, are operatively and detachably connected through locking assemblies.

4. The splitable modular doghouse as claimed in claim 3, wherein the at least one third doghouse body comprise a plurality of the third doghouse bodies, a side of each of the plurality of third doghouse bodies is operatively and detachably connected to another side of another of the plurality of third doghouse bodies through the locking assemblies.

5. The splitable modular doghouse as claimed in claim 3, wherein a top part of a sidewall of the first doghouse body is provided with a first boss, and a bottom part of a sidewall of the second doghouse body is provided with a second boss, a bottom part of a first sidewall of the at least one third doghouse body is provided with a second boss, a top part of a second sidewall of the at least one third doghouse body is provided with a first boss, the first boss of the first doghouse body is located just above the second boss of the at least one third doghouse body, and the first boss of the at least one third doghouse body is located just above the second boss of the second doghouse body.

6. The splitable modular doghouse as claimed in claim 2, wherein each of the locking assemblies comprises: a snap member, a lock member, and two snap rings; the snap member and a first snap ring of the two snap rings are both disposed on the first boss, the snap member is engaged with the first snap ring; the lock member and a second snap ring of the two snap rings are both disposed on the second boss, the lock member is engaged with the second snap ring, and the snap member is engaged with the lock member.

7. The splitable modular doghouse as claimed in claim 6, wherein the first boss is provided with a first through-groove, the second boss is provided with a second through-groove, and the first through-groove is aligned with the second through-groove;
wherein an upper end of the snap member is engaged with and positionally limited by an upper surface of the first boss, a lower end of the snap member extends into the first through-groove, a lower end of the first snap ring is engaged with and positionally limited by a lower surface of the first boss, and an upper end of the first snap ring extends into the first through-groove and is snapped with the lower end of the snap member;
wherein an upper end of the lock member is engaged with the snap member, a middle part of the lock member is engaged with and positionally limited by an upper surface of the second boss, a lower end of the lock member extends into the second through-groove, a lower end of the second snap ring is engaged with and positionally limited by a lower surface of the second boss, and an upper end of the second snap ring extends into the second through-groove and is snapped with the lower end of the lock member.

8. The splitable modular doghouse as claimed in claim 7, wherein the lock member comprises a first lock portion and a second lock portion sequentially connected along a direction from top to bottom, an upper end of the second lock portion is engaged with and positionally limited by the upper surface of the second boss, a lower end of the second lock portion extends into the second through-groove, the upper end of the second snap ring is snapped with the lower end of the second lock portion, and the first lock portion extends into the snap member and is engaged with the snap member.

9. The splitable modular doghouse as claimed in claim 8, wherein the lower surface of the first boss at a periphery of the first through-groove is formed with a first groove, and the upper surface of the second boss at a periphery of the second through-groove is formed with a second groove, the first groove is opposite to the second groove, the lower end of the first snap ring is disposed in the first groove, and the upper end of the second lock portion is disposed in the second groove.

10. The splitable modular doghouse as claimed in claim 9, wherein two sides of an inner circumferential wall of the snap member are provided with two stopping plates respectively, a through cavity is formed between the two stopping plates, a middle part of the upper end of the second lock portion is provided with a protruding neck, the protruding neck passes through the through cavity, and the first lock portion is positionally limited by the stopping plates.

11. The splitable modular doghouse as claimed in claim 5, wherein each of the locking assemblies comprises: a snap member, a lock member, and two snap rings; the snap member and a first snap ring of the two snap rings are both disposed on the first boss, the snap member is engaged with the first snap ring; the lock member and a second snap ring of the two snap rings are both disposed on the second boss, the lock member is engaged with the second snap ring, and the snap member is engaged with the lock member.

12. The splitable modular doghouse as claimed in claim 11, wherein the first boss is provided with a first through-groove, the second boss is provided with a second through-groove, and the first through-groove is aligned with the second through-groove;
wherein an upper end of the snap member is engaged with and positionally limited by an upper surface of the first boss, a lower end of the snap member extends into the first through-groove, a lower end of the first snap ring is engaged with and positionally limited by a lower surface of the first boss, and an upper end of the first snap ring extends into the first through-groove and is snapped with the lower end of the snap member;
wherein an upper end of the lock member is engaged with the snap member, a middle part of the lock member is engaged with and positionally limited by an upper surface of the second boss, a lower end of the lock member extends into the second through-groove, a lower end of the second snap ring is engaged with and positionally limited by a lower surface of the second boss, and an upper end of the second snap ring extends into the second through-groove and is snapped with the lower end of the lock member.

13. The splitable modular doghouse as claimed in claim 12, wherein the lock member comprises a first lock portion and a second lock portion sequentially connected along a direction from top to bottom, an upper end of the second lock portion is engaged with and positionally limited by the upper surface of the second boss, a lower end of the second lock portion extends into the second through-groove, the upper end of the second snap ring is snapped with the lower end of the second lock portion, and the first lock portion extends into the snap member and is engaged with the snap member.

14. The splitable modular doghouse as claimed in claim 13, wherein the lower surface of the first boss at a periphery of the first through-groove is formed with a first groove, and the upper surface of the second boss at a periphery of the second through-groove is formed with a second groove, the first groove is opposite to the second groove, the lower end of the first snap ring is disposed in the first groove, and the upper end of the second lock portion is disposed in the second groove.

15. The splitable modular doghouse as claimed in claim 14, wherein two sides of an inner circumferential wall of the snap member are provided with two stopping plates respectively, a through cavity is formed between the two stopping plates, a middle part of the upper end of the second lock portion is provided with a protruding neck, the protruding neck passes through the through cavity, and the first lock portion is positionally limited by the stopping plates.
